(19) United States
(12) Patent Application Publication
(10) Pub. No.: US 2007/0046024 A1
(43) Pub. Date: Mar. 1, 2007

(54) Fluid connector

(76) Inventor: Yuan-Ching Liao, Chia-Yi Hsien (TW)

Correspondence Address: LADAS & PARRY, 5670 WILSHIRE BOULEVARD, SUITE 2100, LOS ANGELES, CA, 90036-5679, US

(21) Appl. No.: 11/218,245

(22) Filed: Sep. 1, 2005

(51) Int. Cl. F16L 27/00

(52) U.S. Cl. 285/272

(57) ABSTRACT

A fluid connector includes: a first part formed with a first annular groove and having a first inner ring, and a first engaging member disposed coaxially with the first inner ring and formed with a neck; a second part formed with a second annular groove that is aligned with the first annular groove, and having a second inner ring sealingly connected to the first inner ring, and a second engaging member disposed coaxially with the second inner ring, and formed with a shoulder which engages the neck; and first and second conduits respectively connected to the first and second parts and in fluid communication with the first and second annular grooves.

### BACKGROUND OF THE INVENTION

1. Field of the Invention

The invention relates to a fluid connector, more particularly to a fluid connector that is capable of conducting fluid flow.

2. Description of the Related Art

Referring to FIGS. 1 to 3, a conventional fluid connector capable of conducting fluid flow is shown to include first and second parts 11, 12 that are pivotably connected to each other, and first and second covers 13, 14 that respectively cover two opposite open ends of the second part 12. The first part 11 is pivotably held to the second part 12 through a screw 15 which engages threadedly a post 132 of the first cover 13. The first part 11 includes a first threaded section 111 adapted for connecting to a fluid conduit (not shown), and an annular connecting housing 112 that extends from the first threaded section 111 and that defines an annular first groove 113 therein. The second part 12 includes a second threaded section 121 adapted for connecting to another fluid conduit or a nozzle, and a pair of opposite annular connecting rings 122 that extend from the second threaded section 121 and that define the open ends, respectively. The connecting housing 112 is coaxially sandwiched between the connecting rings 122. The first cover 13 includes a cover base 131, a first sleeve 133 that extends axially from the cover base 131, a second sleeve 135 that extends axially from the cover base 131 and that is coaxially surrounded by and that cooperates with the first sleeve 133 to define a second groove 136 therebetween. The first sleeve 133 is formed with a through-hole 134 in fluid communication with the second groove 136. The first and second grooves 113, 136 cooperatively form a fluid path when the first and second connector parts 11, 12 are coupled together.

In use, the first and second parts 11, 12 are pivoted relative to each other to a desired angle so as to conduct the flow direction of a fluid passing through the fluid path defined by the first and second grooves 113, 136.

The conventional fluid connector is disadvantageous in that the width (w) of the fluid path defined by the first and second grooves 113, 136 is relatively small due to occupation of a portion of the middle space between the first and second connecting rings 122 by the second cover 14 and the connecting housing 112 of the first part 11, which results in a decrease in the fluid flowing rate. Moreover, assembly and disassembly of the first and second parts 11, 12 are carried out through tightening and loosening of the screw 15, which is relatively inconvenient.

### SUMMARY OF THE INVENTION

Therefore, the object of the present invention is to provide a fluid connector that can overcome the aforesaid drawbacks associated with the prior art.

According to the present invention, a fluid connector comprises: a first part formed with a first annular groove that defines an axis, and having a first inner ring that confines an inner side of the first annular groove, and a first engaging member that is connected to and that is disposed coaxially with the first inner ring, and that is formed with a neck disposed around the axis; a second part coupled to the first part, formed with a second annular groove that is aligned with and that is in fluid communication with the first annular groove, and having a second inner ring that confines an inner side of the second annular groove and that is sealingly connected to the first inner ring, and a second engaging member that is connected to and that is disposed coaxially with the second inner ring, and that is formed with a shoulder which engages the neck, thereby preventing removal of the first part from the second part and permitting pivoting movement of the first part relative to the second part; a first conduit connected to the first part and in fluid communication with the first annular groove; and a second conduit connected to the second part and in fluid communication with the second annular groove.

### BRIEF DESCRIPTION OF THE DRAWINGS

Other features and advantages of the present invention will become apparent in the following detailed description of the preferred embodiment with reference to the accompanying drawings, of which:

FIG. 1 is an assembled perspective view of a conventional fluid connector;

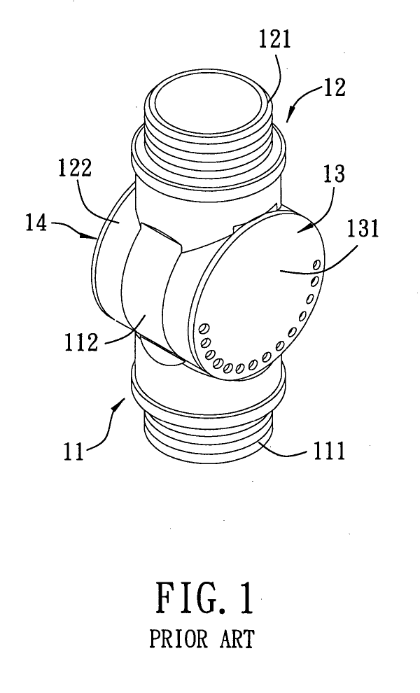

FIG. 2 is an exploded perspective view of the conventional fluid connector;

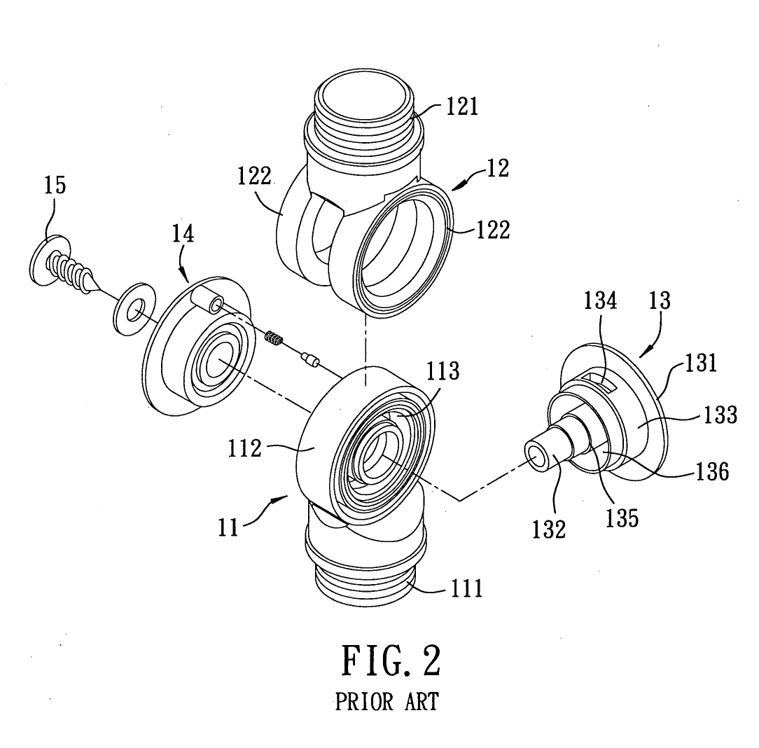

FIG. 3 is a sectional view of the conventional fluid connector;

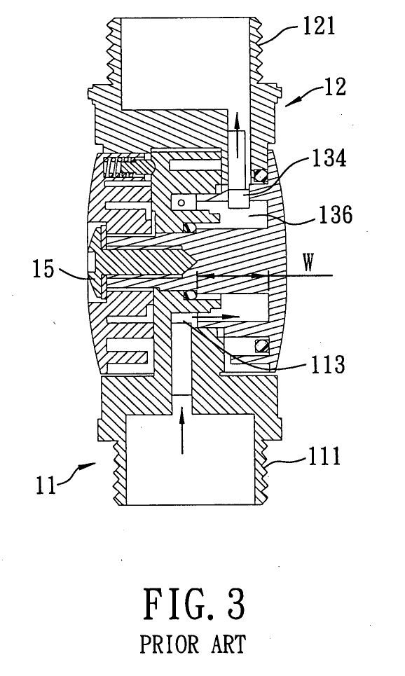

FIG. 4 is an assembled perspective view of the preferred embodiment of the fluid connector according to the present invention;

FIG. 5 is an exploded perspective view of the preferred embodiment; and

FIG. 6 is a sectional view of the preferred embodiment.

### DETAILED DESCRIPTION OF THE PREFERRED EMBODIMENT

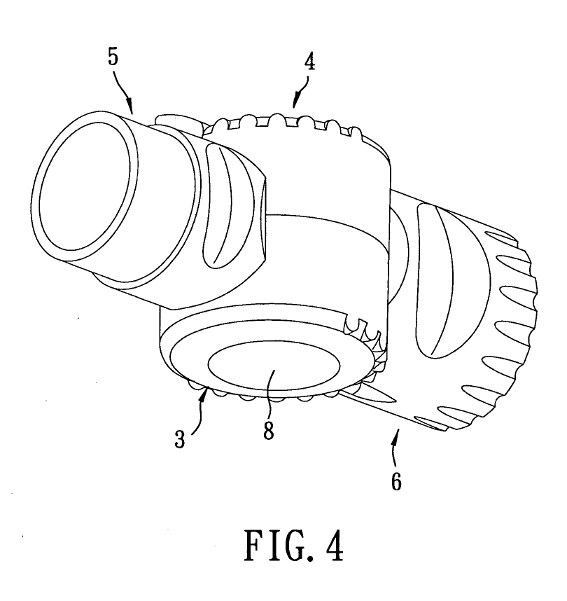

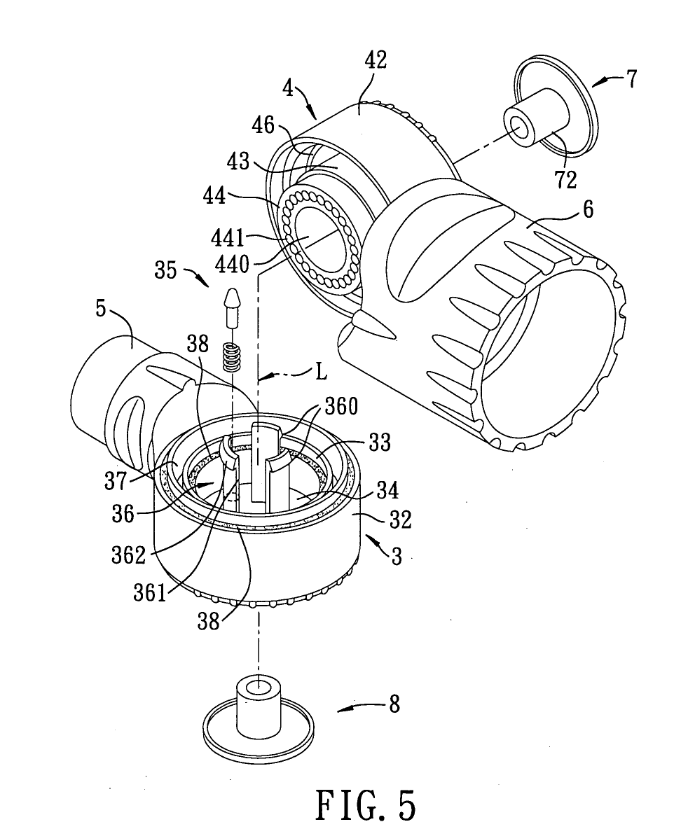

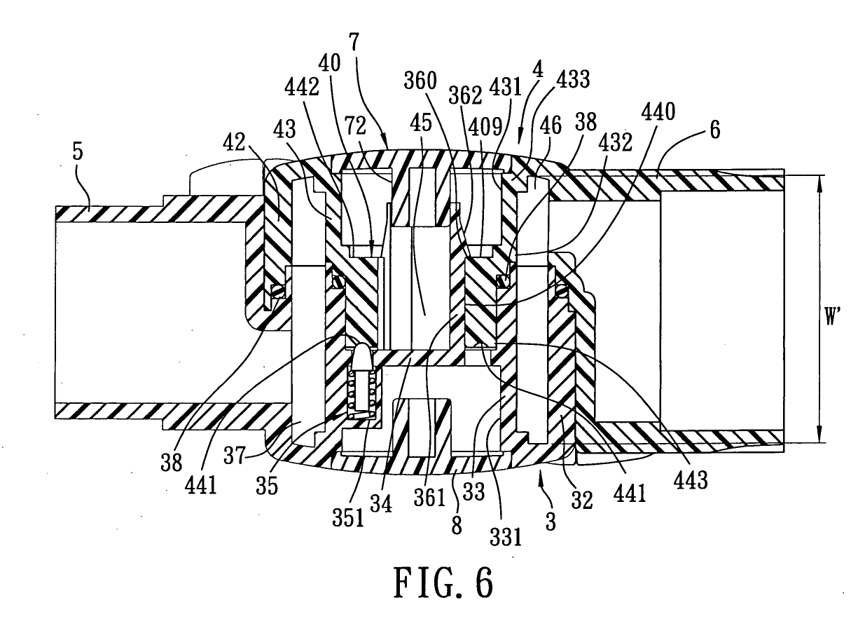

Referring to FIGS. 4 to 6, the preferred embodiment of a fluid connector according to the present invention is shown to include: a first part 3 formed with a first annular groove 37 that defines an axis (L), and having a first inner ring 33 that confines an inner side of the first annular groove 37, and a first engaging member 36 that is connected to and that is disposed coaxially with the first inner ring 33, and that is formed with a neck 360 disposed around the axis (L); a second part 4 coupled to the first part 3, formed with a second annular groove 46 that is aligned with and that is in fluid communication with the first annular groove 37, and having a second inner ring 43 that confines an inner side of the second annular groove 46 and that is sealingly connected to the first inner ring 33, and a second engaging member 40 that is connected to and that is disposed coaxially with the second inner ring 43, and that is formed with a shoulder 409 which engages the neck 360, thereby preventing removal of the first part 3 from the second part 4 and permitting pivoting movement of the first part 3 relative to the second part 4; a first conduit 5 connected to the first part 3 and in fluid communication with the first annular groove 37; and a second conduit 6 connected to the second part 4 and in fluid communication with the second annular groove 46.

The first inner ring 33 has a first inner surface 331 that is formed with a supporting plate 34 extending radially and inwardly therefrom. The first engaging member 36 includes a plurality of resilient arms 361 that extend axially from the supporting plate 34 and that are angularly displaced from one another. Each of the resilient arms 361 has a free end that is formed with a barb 362 protruding radially therefrom. The barbs 362 of the resilient arms 361 cooperatively define the neck 360. The second inner ring 43 has a second inner surface 431. The second engaging member 40 includes an annular positioning wall 44 that is coaxially disposed with the second inner ring 43, that defines a guiding hole 440, and that has a first end 442 extending radially and inwardly from the second inner surface 431 and having an end face defining the shoulder 409. The barbs 362 cooperatively define a diameter that is greater than that of the guiding hole 440. The resilient arms 361 are resilient so as to permit the barbs 362 to pass through the guiding hole 440 to engage the shoulder 409 in a snap engaging manner when the resilient arms 361 are inserted through the guiding hole 440 to couple the first and second parts 3, 4.

The second inner ring 43 has an inner open end 432 and an outer open end 433 that is opposite to the inner open end 432. The positioning wall 44 extends axially and outwardly from the inner open end 432 of the second inner ring 43. The resilient arms 361 extend through the inner open end 432 of the second inner ring 43 and into the second inner ring 43. The free ends of the resilient arms 361 cooperatively define an inner space 45 thereamong. The fluid connector further includes a cover 7 that covers the outer open end 433 and that is formed with an annular protrusion 72 which extends therefrom into the inner space 45 defined by the free ends of the resilient arms 361 and which presses against the free ends of the resilient arms 361 in radial outward directions, thereby preventing undesired disengagement between the neck 360 and the shoulder 409. The fluid connector further includes a cap 8 that covers an outer open end of the first inner ring 33 of the first part 3.

The positioning wall 44 has a second end 443 opposite to the first end 442 and having an end face that is formed with a plurality of retaining grooves 441 that are angularly displaced from one another. The fluid connector further includes a spring-biased pin 35 that is mounted on the first part 3, that extends axially through the supporting plate 34 toward the second end 443 of the positioning wall 44, and that is axially movable relative to the positioning wall 44. The spring-biased pin 35 is urged by an urging force to engage releasably a selected one of the retaining grooves 441 so as to position the first and second parts 3, 4 at a desired angle therebetween. A pin-receiving member 351 is formed on the first inner ring 33 for accommodating the spring-biased pin 35 therein. In this embodiment, the spring-biased pin 35 has a pin head with a diameter larger than that of each retaining groove 441 for permitting relative rotation of the first and second parts 3, 4.

A sealing ring 38 is disposed between the first and second inner rings 33, 43 for isolating sealingly a fluid path defined by the first and second annular grooves 37, 46.

The first part 3 further includes a first outer ring 32 that confines an outer side of the first annular groove 37. The second part 4 further includes a second outer ring 42 that confines an outer side of the second annular groove 46 and that is connected to the first outer ring 32 through another sealing ring 38 disposed therebetween.

In use, one of the first and second conduits 5, 6 can be connected to a pipe, while the other of the first and second conduits 5, 6 can be connected to a nozzle.

During assembly, the resilient arms 361 of the first engaging member 36 are inserted through the guiding hole 440 of the positioning wall 44 to permit snap engagement between the barbs 362 and the shoulder 409 of the second engaging member 40. As such, assembly of the first and second parts 3, 4 is relatively ease as compared to the aforesaid conventional fluid connector. Moreover, by virtue of the configuration of the first and second parts 3, 4, the width (w′) of the fluid path defined by the first and second annular grooves 37, 46 is larger than that of the aforesaid conventional fluid connector.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A fluid connector comprising:
a first part formed with a first annular groove that defines an axis, and having a first inner ring that confines an inner side of said first annular groove, and a first engaging member that is connected to and that is disposed coaxially with said first inner ring, and that is formed with a neck disposed around said axis;
a second part coupled to said first part, formed with a second annular groove that is aligned with and that is in fluid communication with said first annular groove, and having a second inner ring that confines an inner side of said second annular groove and that is sealingly connected to said first inner ring, and a second engaging member that is connected to and that is disposed coaxially with said second inner ring, and that is formed with a shoulder which engages said neck, thereby preventing removal of said first part from said second part and permitting pivoting movement of said first part relative to said second part;
a first conduit connected to said first part and in fluid communication with said first annular groove; and
a second conduit connected to said second part and in fluid communication with said second annular groove.

2. The fluid connector as claimed in claim 1, wherein said first inner ring has a first inner surface that is formed with a supporting plate extending radially and inwardly therefrom, said first engaging member including a plurality of resilient arms that extend axially from said supporting plate and that are angularly displaced from one another, each of said resilient arms having a free end that is formed with a barb protruding radially therefrom, said barbs of said resilient arms cooperatively defining said neck, said second inner ring having a second inner surface, said second engaging member including an annular positioning wall that is coaxially disposed with said second inner ring, that defines a guiding hole, and that has a first end extending radially and inwardly from said second inner surface and having an end face defining said shoulder, said barbs cooperatively defining a diameter greater than that of said guiding hole, said resilient arms being resilient so as to permit said barbs to pass through said guiding hole to engage said shoulder in a snap engaging manner when said resilient arms are inserted through said guiding hole to couple said first and second parts.

3. The fluid connector as claimed in claim 2, wherein said second inner ring has an inner open end and an outer open end that is opposite to said inner open end, said positioning wall extending axially and outwardly from said inner open end of said second inner ring, said resilient arms extending through said inner open end of said second inner ring and into said second inner ring, said free ends of said resilient arms cooperatively defining an inner space thereamong, said fluid connector further comprising a cover that covers said outer open end and that is formed with an annular protrusion which extends into said inner space defined by said free ends of said resilient arms and which presses against said free ends of said resilient arms in radial outward directions, thereby preventing undesired disengagement between said neck and said shoulder.

4. The fluid connector as claimed in claim 3, wherein said positioning wall has a second end opposite to said first end and having an end face that is formed with a plurality of retaining grooves that are angularly displaced from one another, said fluid connector further comprising a spring-biased pin that is mounted on said first part, that extends axially through said supporting plate toward said second end of said positioning wall, and that is axially movable relative to said positioning wall, said spring-biased pin being urged by an urging force to engage releasably a selected one of said retaining grooves so as to position said first and second parts at a desired angle therebetween.
